(19) United States
(12) Patent Application Publication
(10) Pub. No.: US 2013/0044040 A1
(43) Pub. Date: Feb. 21, 2013

(54) INFORMATION PROCESSING APPARATUS AND ANTENNA EXTENSION SYSTEM

(71) Applicant: Kimihiro MARUYAMA, Shinagawa (JP)

(72) Inventor: Kimihiro MARUYAMA, Shinagawa (JP)

(73) Assignee: FUJITSU COMPONENT LIMITED, Tokyo (JP)

(21) Appl. No.: 13/532,960

(22) Filed: Jun. 26, 2012

(30) Foreign Application Priority Data
Aug. 19, 2011 (JP) 2011-179533

(51) Int. Cl. H01Q 1/50; H01Q 21/00

(52) U.S. Cl. 343/876; 343/906; 343/893

(57) ABSTRACT

An information processing apparatus, includes: a first connector that attaches a portable module incorporating an antenna; and a first antenna that transmits and receives a signal to/from the antenna; wherein when the portable module is attached to the first connector, the first antenna is fixed at a position on a substrate which is opposed to the antenna, and the first antenna is connected to a second antenna having a gain larger than a gain of the first antenna.

### CROSS-REFERENCE TO RELATED APPLICATION

This application is based upon and claims the benefit of priority of the prior Japanese Patent Application No. 2011-179533, filed on Aug. 19, 2011, the entire contents of which are incorporated herein by reference.

### FIELD

A certain aspect of the embodiments discussed herein is related to an information processing apparatus and an antenna extension system.

### BACKGROUND

Conventionally, there has been known a receiver that includes an internal antenna, an external antenna, and a switcher that selectively supplies a power supply to any one of the internal antenna and the external antenna according to a current which flows to the external antenna (see Japanese Laid-Open Patent Application Publication No. 2006-287298).

Recently, a communication unit having an antenna, such as a wireless LAN (Local Area Network) and Bluetooth, is downsized. This communication unit may be mounted in a small card module, such as a SD (Secure Digital) memory card and a memory stick. The standard of the small card module is made on the assumption that the small card module is built in a host device like a PC (Personal Computer) or a digital camera.

### SUMMARY

According to an aspect of the present invention, there is provided an information processing apparatus, including: a first connector that attaches a portable module incorporating an antenna; and a first antenna that transmits and receives a signal to/from the antenna; wherein when the portable module is attached to the first connector, the first antenna is fixed at a position on a substrate which is opposed to the antenna, and the first antenna is connected to a second antenna having a gain larger than a gain of the first antenna.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating the schematic configuration of an information processing apparatus which has incorporated a card module according to a first embodiment;

FIG. 2 is a perspective view illustrating the schematic configuration of the information processing apparatus which has incorporated the card module according to the first embodiment;

FIG. 3 is a block diagram illustrating the schematic configuration of the information processing apparatus which has incorporated the card module according to a second embodiment;

FIG. 4 is a perspective view illustrating the schematic configuration of the information processing apparatus which has incorporated the card module according to the second embodiment;

FIG. 5 is a block diagram illustrating the schematic configuration of the card module and the information processing apparatus which has incorporated the card module according to a third embodiment;

FIG. 6A is a schematic cross-section diagram of the card module and the information processing apparatus before the card module is attached to a card connector;

FIG. 6B is a schematic cross-section diagram of the card module and the information processing apparatus after the card module is attached to the card connector; and

FIGS. 7A and 7B are diagrams illustrating the appearance of the card module.

### DESCRIPTION OF EMBODIMENTS

A description will now be given of an exemplary embodiment with reference to the accompanying drawings.

### First Embodiment

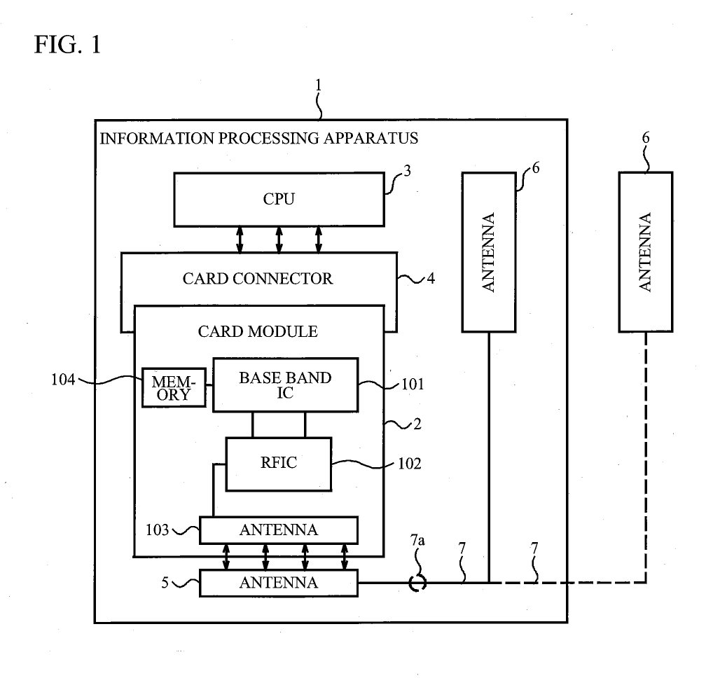

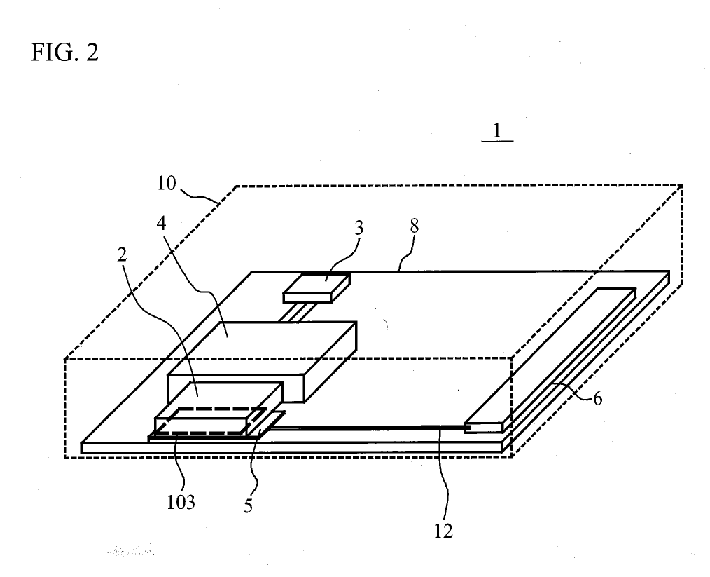

FIG. 1 is a block diagram illustrating the schematic configuration of an information processing apparatus which has incorporated a card module according to a first embodiment. FIG. 2 is a perspective view illustrating the schematic configuration of the information processing apparatus which has incorporated the card module according to the first embodiment.

In FIG. 1, an information processing apparatus 1 can incorporate a card module 2 as a portable module, and is a digital camera, a cell phone, a game machine, a computer, or the like, for example. The information processing apparatus 1 includes: a CPU 3 that performs various data processes and controls the whole apparatus; a card connector 4 (i.e., a first connector) for attaching the card module 2; an antenna 5 (i.e., a first antenna) for communicating data with the card module 2; an antenna 6 (i.e., a second antenna) having a larger gain than the antenna 5; and an impedance line 7 that connects between the antenna 5 and the antenna 6. The gain indicates the strength of energy in a radiation angle in which the radiation of an electric wave serves as a maximum, in an antenna with directivity.

The antenna 6 is incorporated into the information processing apparatus 1, but may be provided at the outside of the information processing apparatus 1, as illustrated be a dashed line. To enable attachment and detachment of the antenna 6, a connector 7a (i.e., a third connector) may be provided between the antenna 5 and the antenna 6. The CPU 3 is connected to the card connector 4, and communicates with the card module 2 via the card connector 4.

In addition, the information processing apparatus 1 further includes a substrate 8 and a housing 10, as illustrated in FIG. 2. The CPU 3, the card connector 4, the antenna 5 and the antenna 6 are fixed on the substrate 8. The housing 10 is indicated by a dashed line. The antenna 5 is fixed at a position on the substrate 8 which is opposed to an antenna 103 in the card module 2 when the card module 2 is attached to the card connector 4. Thus, the antenna 5 is fixed at the position which is opposed to an antenna 103, and hence a high frequency signal flows between the antenna 103 and the antenna 5 without few loss of the gain. The impedance line 7 may be a physical signal line, but may be formed as a pattern on the substrate 8. When the antenna 6 is incorporated into the information processing apparatus 1, the antenna 6 is fixed to a position (for example, a position where a conductor such as a battery does not interfere in the antenna 6) on the substrate 8 where the antenna 6 can transmit and receive an electric wave normally.

Referring again to FIG. 1, the card module 2 has a wireless communication function and can be incorporated or built into the information processing apparatus 1. The card module 2 is a SD (Secure Digital) memory card or a memory stick which incorporates an antenna for wireless communication, for example. The wireless communication is a wireless LAN (Local Area Network) or Bluetooth.

The card module 2 includes a base band IC (Integrated Circuit) 101, a RFIC (Radio-Frequency Integrated Circuit) 102, the antenna 103, and a memory 104. The antenna 103 of the card module 2 can be used as an independent antenna even when the card module 2 is used alone, i.e., not connected to the card connector 4. Therefore, the card module 2 can also be attached to an information processing apparatus which does not include the antenna 5 and the antenna 6. The base band IC 101 is connected to the RFIC 102 and the memory 104. The RFIC 102 is connected to the antenna 103.

The base band IC 101 is a circuit that processes data signal before modulating and demodulating to a high-frequency signal. The base band IC 101 communicates with the CPU 3 via the card connector 4, stores the data signal as data into the memory 104, and reads out data from the memory 104. The RFIC 102 is a circuit that converts data signal from the base band IC 101 into a signal corresponding to a transmission frequency of the antenna 103, and converts a reception signal of the antenna 103 into a signal corresponding to a frequency which the base band IC 101 can process. Thus, the RFIC 102 functions as a frequency conversion circuit.

The antenna 103 has the same characteristics (i.e., the gain and the directivity) as the antenna 5, and is smaller than the antenna 6 with respect to the gain. The antenna 103 is opposed to the antenna 5 through a space of about several millimeters. Therefore, a gain loss of about several decibels occurs in the high-frequency signal which flows between the antenna 103 and the antenna 5, but a practical problem does not occur. Therefore, when the card module 2 is incorporated or built into the information processing apparatus 1, the high-frequency signal can be transmitted and received via the antenna 6. As a result, a problem that the electric wave cannot be radiated normally from the antenna 103 is solved.

As described above, according to the first embodiment, the information processing apparatus 1 includes; the card connector 4 that attaches the card module 2 incorporating the antenna 103; and the antenna 5 that transmits and receives the high-frequency signal to/from the antenna 103. When the card module 2 is attached to the card connector 4, the antenna 5 is fixed at a position on the substrate 8 which is opposed to an antenna 103 and connected to the antenna 6 having a gain larger than the gain of the antenna 5. Therefore, since the high-frequency signal as the electric wave flows between the antenna 103 in the card module 2 and the antenna 6 via the antenna 5, the electric wave can be transmitted and received to/from the card module 2 even when the card module 2 is incorporated or built into the information processing apparatus 1.

### Second Embodiment

In a second embodiment, the configuration of the information processing apparatus is different from that of the information processing apparatus 1 according to the first embodiment. Here, component elements that are the same as component elements in the information processing apparatus 1 and the card module 2 are designated by identical reference numerals.

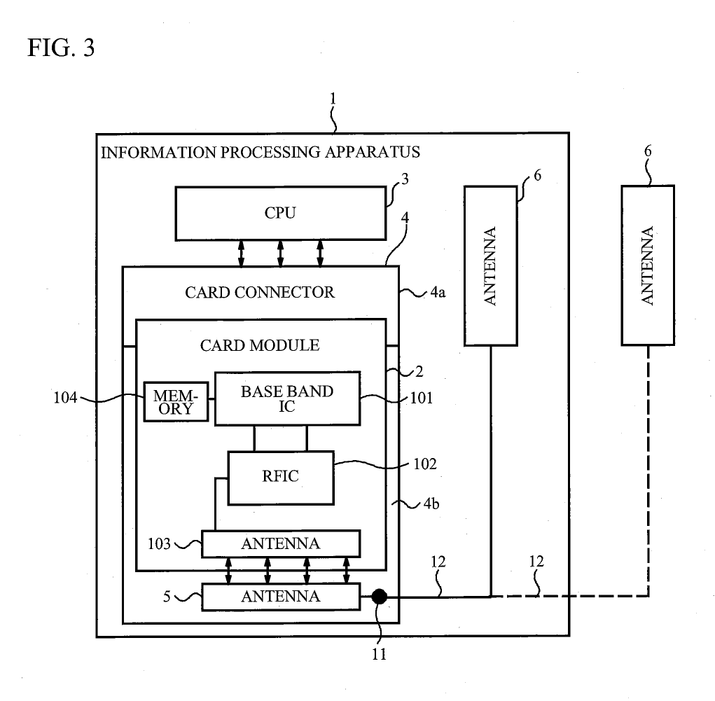

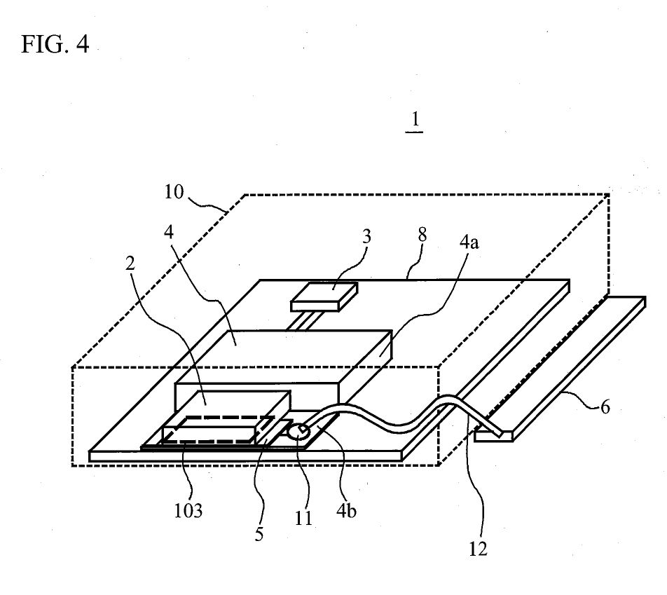

FIG. 3 is a block diagram illustrating the schematic configuration of the information processing apparatus which has incorporated the card module according to the second embodiment. FIG. 4 is a perspective view illustrating the schematic configuration of the information processing apparatus which has incorporated the card module according to the second embodiment.

In the information processing apparatus 1 according to the second embodiment, the shape of the card connector 4 is expanded, as illustrated in FIGS. 3 and 4. Specifically, the card connector 4 includes a main unit 4a that attaches the card module 2, and a bottom unit 4b that expands an attachment area to the substrate 8. Here, the card connector 4 of the second embodiment is different in including the bottom unit 4b from that of the first embodiment. Each of the main unit 4a and the bottom unit 4b is formed alone, or the main unit 4a and the bottom unit 4b are formed integrally.

The antenna 5 and an RF (Radio-Frequency) connector 11 (a second connector) are fixed on the bottom unit 4b of the card connector 4. In the second embodiment, the antenna 5 is fixed at a position on the bottom unit 4b which is opposed to the antenna 103 in the card module 2 when the card module 2 is attached to the main unit 4a of the card connector 4.

In the first embodiment, a designer of the information processing apparatus 1 needs to decide the position of the antenna 5 on the substrate 8 according to a position of the card connector 4 on the substrate 8, or needs to decide the position of the card connector 4 on the substrate 8 according to the position of the antenna 5 on the substrate 8. On the contrary, in the second embodiment, the antenna 5 is fixed on the bottom unit 4b of the card connector 4, and hence the designer of the information processing apparatus 1 can decide the position of the card connector 4 on the substrate 8 without taking into consideration the position of the antenna 5 on the substrate 8.

The RF connector 11 is connected to the antenna 6 via a coaxial cable 12. Therefore, the antenna 6 and the coaxial cable 12 are detachable. The antenna 6 may be provided at the inside or outside of the information processing apparatus 1. When the antenna 6 is incorporated into the information processing apparatus 1, the antenna 6 is fixed to a position (for example, a position where a conductor such as a battery does not interfere in the antenna 6) on the substrate 8 where the antenna 6 can transmit and receive an electric wave normally.

In addition, the RF connector 11 may be fixed on the substrate 8 as substitute for the bottom unit 4b of the card connector 4. In this case, the antenna 6 and the coaxial cable 12 are also detachable.

As described above, according to the second embodiment, the card connector 4 includes the main unit 4a that attaches the card module 2, and the bottom unit 4b that expands the attachment area to the substrate 8. The antenna 5 is fixed at the position on the bottom unit 4b which is opposed to the antenna 103. Therefore, the designer of the information processing apparatus 1 can decide the position of the card connector 4 on the substrate 8 without taking into consideration the position of the antenna 5 on the substrate 8.

### Third Embodiment

In the first and the second embodiments, the high-frequency signal is transmitted between the antenna 5 and the antenna 103, and the card module 2 uses the antenna 6 for transmission and reception of the electric wave. In a third embodiment, a plurality of switches that selectively switches the antenna 6 and the antenna 103 are provided in the information processing apparatus 1 and the card module 2, respectively. Thereby, the card module 2 can use the antenna 6 for transmission and reception of the electric wave.

In the third embodiment, the configuration of the information processing apparatus and the card module is different from that of the information processing apparatus and the card module of the second embodiment. Here, component elements that are the same as component elements in the information processing apparatus 1 and the card module 2 are designated by identical reference numerals.

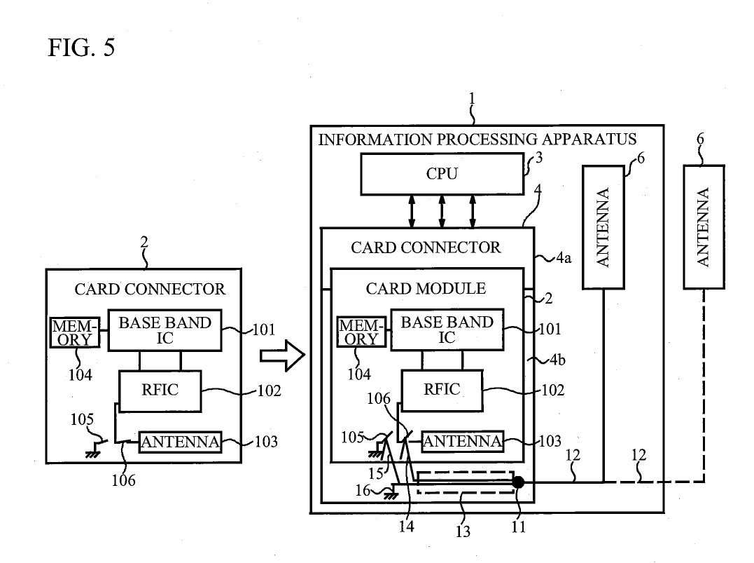

FIG. 5 is a block diagram illustrating the schematic configuration of the card module and the information processing apparatus which has incorporated the card module according to the third embodiment.

In FIG. 5, the card module 2 includes a switch 105 connected to a ground, and a switch 106 that switches on/off connection between the RFIC 102 and the antenna 103. Here, the card module 2 may include a plurality of switches 105 and a plurality of switches 106. Before the card module 2 is attached to the card connector 4, the switch 106 switches on the connection between the RFIC 102 and the antenna 103. The switches 105 and 106 are formed with a conductor.

On the other hand, the information processing apparatus 1 includes RF (Radio-Frequency) switches 14 and 15 (a switch portion) formed with a conductor. The information processing apparatus 1 may include a plurality of switches 14 and a plurality of switches 15. A strip line 13 with a RF ground 16 is formed between the RF switches 14 and 15 and the RF connector 11. The RF connector 11, the RF ground 16 and the strip line 13 are fixed on the bottom unit 4b of the card connector 4.

The RF switches 14 and 15 are provided on the bottom unit 4b of the card connector 4. One end of the RF switch 14 is a deformable free end (i.e., an unfixed end) capable of coming in contact with the switch 106, and other end of the RF switch 14 is connected to the strip line 13. One end of the RF switch 15 is a deformable free end (i.e., an unfixed end) capable of coming in contact with the switch 105, and other end of the RF switch 15 is connected to the strip line 13.

When the card module 2 is attached to the card connector 4, the RF switch 14 comes in contact with the switch 106 and the RF switch 15 comes in contact with the switch 105. That is, when the card module 2 is attached to the card connector 4, the switches 105 and 106 or the RF switches 14 and 15 are switched simultaneously. In this case, the RF switch 14 comes in contact with the switch 106 of the card module 2, and hence the high-frequency signal flows between the RFIC 102 and the antenna 6 via the RF switch 14 and the switch 106 of the card module 2. That is, the antenna 103 is not used.

In addition, the RF switch 15 connects the switch 105 connected to a ground in the card module 2 to the RF ground 16.

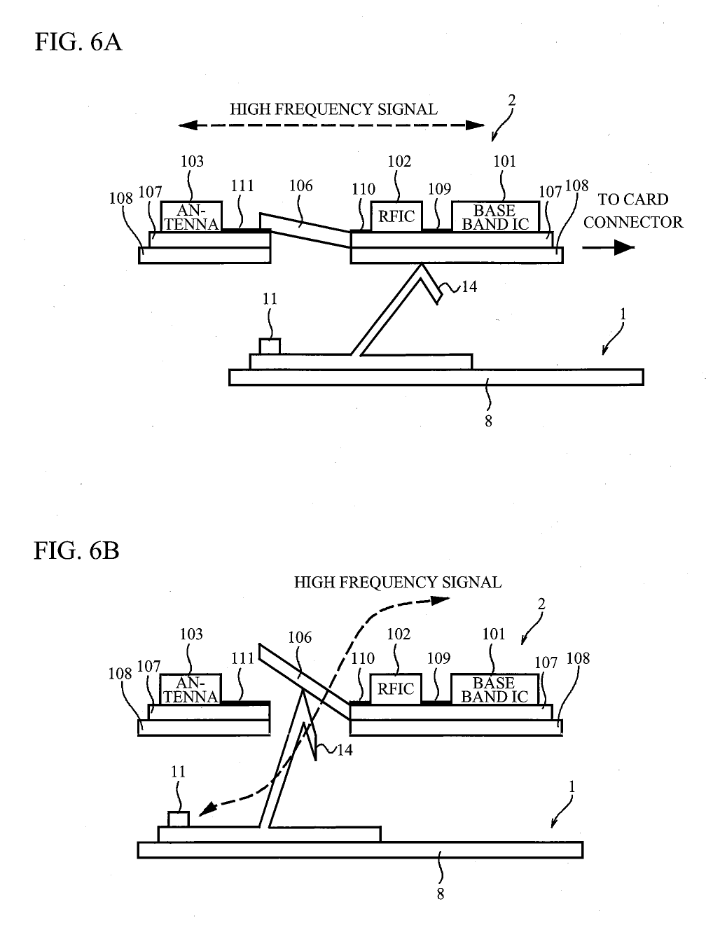

FIG. 6A is a schematic cross-section diagram of the card module 2 and the information processing apparatus 1 before the card module 2 is attached to the card connector 4. FIG. 6B is a schematic cross-section diagram of the card module 2 and the information processing apparatus 1 after the card module 2 is attached to the card connector 4.

The base band IC 101, the RFIC 102 and the antenna 103 are fixed on a substrate 107 of the card module 2, and the substrate 107 is covered with a housing 108 of the card module 2. The housing 108 is composed of an insulator. The switch 106 is provided between the RFIC 102 and the antenna 103. A pattern 109 connecting the base band IC 101 and the RFIC 102 is formed on the substrate 107. A pattern 110 connecting the RFIC 102 and the switch 106 is formed on the substrate 107. In addition, a pattern 111 connecting the antenna 103 and the switch 106 is formed on the substrate 107. Since the switch 106 is a conductor, the pattern 110 and the pattern 111 are electrically connectable via the switch 106.

Before the card module 2 is attached to the card connector 4, the RF switch 14 comes in contact with the housing 108 of the card module 2 and is depressed, as illustrated in FIG. 6A. After the card module 2 is attached to the card connector 4, the RF switch 14 pushes up the switch 106 of the card module 2, as illustrated in FIG. 6B. Thereby, the high-frequency signal from the RFIC 102 is not transmitted to the antenna 103, and flows to the RF connector 11 via the switch 106 and the RF switch 14. On the contrary, the high-frequency signal from the RF connector 11 flows to the RFIC 102 via the switch 106 and the RF switch 14.

The RF switches 14 and 15 are elastic deformable switches as illustrated in FIGS. 6A and 6B. In FIGS. 6A and 6B, the RF switch 15 and the switch 105 are not illustrated. However, when the card module 2 and the information processing apparatus 1 are seen from the side surfaces thereof, the RF switch 15 and the switch 105 are in the same position as the RF switch 14 and the switch 106, respectively.

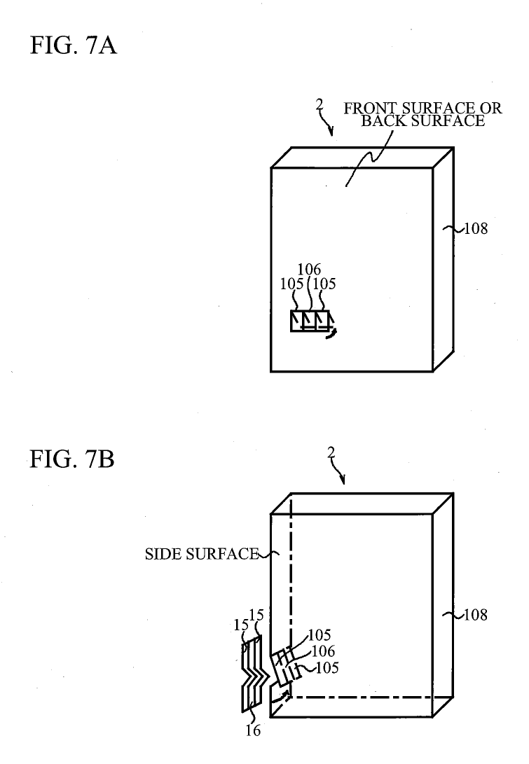

FIGS. 7A and 7B are diagrams illustrating the appearance of the card module.

As illustrated in FIG. 7A, the switches 105 and 106 are exposed from a part of the front surface or the back surface of the housing 108 of the card module 2. On the contrary, in FIG. 7B, the switches 105 and 106 are exposed from a part of the side surface of the housing 108 of the card module 2. When the card module 2 is attached to the card connector 4, the switches 105 and 106 are pushed up in an inside direction of the housing 108 by the RF switches 15 and 14, respectively.

As described above, according to the third embodiment, the information processing apparatus 1 includes: the card connector 4 that attaches the card module 2 incorporating the antenna 103 and the RFIC 102; and the RF switch 14 that switches a connection destination of the RFIC 102 from the antenna 103 to another antenna 6 having the gain larger than the gain of the antenna 103 when the card module 2 is attached to the card connector 4. Therefore, since the high-frequency signal as the electric wave flows between the RFIC 102 in the card module 2 and the antenna 6, the electric wave can be transmitted and received to/from the card module 2 even when the card module 2 is incorporated or built into the information processing apparatus 1.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. An information processing apparatus, comprising:
a first connector that attaches a portable module incorporating an antenna; and
a first antenna that transmits and receives a signal to/from the antenna;
wherein when the portable module is attached to the first connector, the first antenna is fixed at a position on a substrate which is opposed to the antenna, and the first antenna is connected to a second antenna having a gain larger than a gain of the first antenna.

2. The information processing apparatus according to claim 1, wherein
the first connector includes a main portion that attaches the portable module and a bottom portion that expands an attachment area to the substrate, and
the first antenna is fixed at a position on the bottom portion which is opposed to the antenna.

3. The information processing apparatus according to claim 2, further comprising a second connector that connects the second antenna to the first antenna, and is fixed to the bottom portion.

4. The information processing apparatus according to claim 1, further comprising a third connector that is connected between the second antenna and the first antenna via a signal line.

5. The information processing apparatus according to claim 1, wherein the second antenna is provided at a position on the substrate where the second antenna is capable of transmitting and receiving an electric wave normally, or is provided at the outside of the information processing apparatus.

6. An information processing apparatus, comprising:
a first connector that attaches a portable module incorporating an antenna and a frequency conversion circuit; and
a switch portion that switches a connection destination of the frequency conversion circuit from the antenna to another antenna having a gain larger than a gain of the antenna when the portable module is attached to the first connector.

7. The information processing apparatus according to claim 6, wherein the portable module includes a first switch connected between the antenna and the frequency conversion circuit,
the switch portion is connected to the another antenna and is an elastic deformable switch, and
when the portable module is attached to the first connector, the switch portion pushes up the first switch so as to cut off connection between the antenna and the frequency conversion circuit.

8. The information processing apparatus according to claim 6, wherein the another antenna is provided at a position on a substrate where the second antenna is capable of transmitting and receiving an electric wave normally, or is provided at the outside of the information processing apparatus.

9. An antenna extension system, comprising:
a portable module that incorporates an antenna;
an information processing apparatus including:
a first connector that attaches the portable module; and
a first antenna that transmits and receives a signal to/from the antenna;
wherein when the portable module is attached to the first connector, the first antenna is fixed at a position on a substrate which is opposed to the antenna, and the first antenna is connected to a second antenna having a gain larger than a gain of the first antenna.

10. An antenna extension system, comprising:
a portable module that incorporates an antenna and a frequency conversion circuit;
an information processing apparatus including:
a first connector that attaches the portable module; and
a switch portion that switches a connection destination of the frequency conversion circuit from the antenna to another antenna having a gain larger than a gain of the antenna when the portable module is attached to the first connector.
